(19) United States
(12) Patent Application Publication
(10) Pub. No.: US 2002/0091630 A1
(43) Pub. Date: Jul. 11, 2002

(54) Loan intermediary processing system and method thereof

(76) Inventor: Akiyoshi Inoue, Tokyo (JP)

Correspondence Address: DANN DORFMAN HERRELL & SKILLMAN, SUITE 720, 1601 MARKET STREET, PHILADELPHIA, PA, 19103-2307, US

(21) Appl. No.: 10/043,064

(22) Filed: Jan. 9, 2002

(30) Foreign Application Priority Data
Jan. 10, 2001 (JP) 2001-2548

(51) Int. Cl. G06F 17/60

(52) U.S. Cl. 705/38

(57) ABSTRACT

To offer a loan intermediary processing system and method thereof, which can reduce the labor on both a loan applicant and financial institutions in a loan application and its examination process. An intermediary processing system that acts as intermediary for the loan applicant and the loan-providing financial institutions, comprising a loan application receiving unit 19, which receives loan application from said loan applicant, a financial institution housing loan terms storing unit 15, which stores the terms of loans from a plurality of financial institutions, a financial institution selecting unit 20, which compares said loan application and the terms of the loan from each financial institution and selects the financial institutions, the loan terms of which the application conditions, a loan application sending unit, which sends the loan application of said loan applicant only to the financial institutions selected by said financial institution selecting unit, and a financial institution examination result processing unit 22, which receives the examination results of said loan application from said financial institutions, sums them up, and presents the summary result to said loan applicant.

### BACKGROUND OF THE INVENTION

1. Field of the Invention

This invention relates to a loan intermediary processing system to process as intermediary when a housing loan applicant applies for a loan from a financial institution, for instance, through the use of the Internet, and the method thereof.

2. Description of the Related Art

In general, when a loan applicant applies for a personal loan such as a housing loan from a financial institution, the applicant would need to visit an office of the financial institution and show a certificate of his income, a copy of real estate register and other necessary certificates. Then, he would have to fill in a designated application form kept at each financial institution with necessary matters, and hand in the application form at counter.

On the other hand, when the financial institution receives a loan application, it would examine the loan applicant's ability to repay the loan based on his age, family structure, occupation, income, etc., and assess the value of the mortgage real estate. Then, it would decide whether to approve or disapprove of the loan application, and offer the terms of the loan.

However, as it is quite natural that each financial institution has its own terms of loan, in many cases, a loan applicant must visit each of the financial institutions during weekdays, fill in an application form with necessary matters and prepare necessary certificates for each institution. Even if the applicant spared his time during weekdays and applied for a loan, he may not be approved for the loan as a result of the examination.

Also, as mentioned above, a financial institution examines the repayment ability of a loan applicant, assesses the real estate value of a mortgage real estate, and then decides on approval or rejection of the loan application and offers terms. Particularly, in general, a specialist carefully examines data such as the public assessment of the land value, the land value investigation, the publicly assessed street value and the publicly assessed value surveys for the last several years, and analyses the disparity among land values to assess the value of the mortgage real estate. To appraise the land value, he searches cases of transactions in the past, and examines the land value by comparison with such cases. As the expert also needs to check each of the past cases of transaction to see if it is a relevant comparison for the object of appraisal, this process takes several days to several weeks.

### SUMMARY OF THE INVENTION

Considering above-mentioned situation, the object of the present invention is to offer a loan intermediary system and the method thereof, which can reduce the labor of both a loan applicant and financial institutions in a loan application and examination process.

To materialize the aforementioned object, according to the first principal aspect of the present invention, there is provided a loan intermediary processing system that acts as intermediary for the loan applicant and the loan-providing financial institutions, comprising a loan application receiving means for receiving loan application from the aforementioned loan applicant, a loan terms storing means for storing terms of loans from a plurality of financial institutions, a financial institution selecting means for comparing the aforementioned loan application with the terms of the loan from each financial institution and selecting the financial institutions that meet the loan application terms, a loan application sending means for send the aforementioned loan applicant's loan application only to the financial institutions selected by the aforementioned financial institution selecting means, and an examination result summary presenting means for summing up the examination results of the aforementioned loan application from the aforementioned financial institutions and presenting the summary result to the aforementioned loan applicant.

According to this configuration, based on the loan application that the loan applicant has entered, the financial institutions, the loan terms of which meet the application conditions, can be selected from a plurality of financial institutions, and the loan application can be sent to these financial institutions. In this manner, by entering the application once, the loan applicant will be able to request examinations to a plurality of financial institutions that are highly likely to approve of the application.

According to one embodiment of the present invention, this system further comprises a mortgage real estate value assessing auxiliary means that generates auxiliary information to assess the real estate value of the mortgage real estate of the loan applicant.

According to this configuration, if a financial institution to which the aforementioned loan application has been made needs an appraisal of the mortgage real estate, the auxiliary information (standard land value, etc.) necessary for this appraisal can be presented to the said financial institution based on the application entered by the aforementioned loan applicant.

According to another embodiment of the present invention, the aforementioned loan application sending means obtains only the information from the aforementioned loan application that is requested by each financial institution and sends the information to respective financial institution.

According to this configuration, based on the loan application entered by the loan applicant, the information appropriate for the loan application form of each financial institution, which is different from one financial institution to another, can be prepared and sent to each financial institution. In this manner, the loan applicant will not need to prepare loan applications in different forms for various financial institutions.

According to another embodiment, it is preferable that the aforementioned mortgage real estate value assessing auxiliary means comprises a map data storing means comprised by associating the land value information and the urban planning drawing information of a plurality of locations with their positional coordinates on the map, a use zoning obtaining means, which obtains the use zoning of the said location to be appraised from the aforementioned urban planning drawing information if a location to be appraised is specified on the map, a comparative case retrieving means, which retrieves comparative cases for the said location to be appraised based on the use zoning obtained by this use zoning obtaining means, and a standard land value computing means, which computes the standard land value of the aforementioned location to be appraised based on the comparative cases retrieved by the aforementioned comparative case retrieving means.

Further, it is desirable that this mortgage real estate value assessing auxiliary means also comprises a publicly-assessed street value obtaining means, which obtains the publicly-assessed street value of the streets with which the location is in contact based on the aforementioned location to be appraised, and that the aforementioned comparative case retrieving means retrieves, in reference to the aforementioned publicly-assessed street value, only the comparative cases whose difference from the said publicly-assessed street value is within a predetermined range.

Further, it is preferable that the aforementioned comparative case retrieving means retrieves only the comparative cases within a predetermined range in reference to the aforementioned location to be appraised. Also, it is further desirable that the aforementioned comparative case retrieving means searches comparative cases for a plurality of use zonings to be searched including the use zoning obtained by the aforementioned use zoning obtaining means, and retrieves the said searched comparative cases being associated with each of the use zonings.

Further, it is preferable that the aforementioned standard land value computing means computes the standard land value of the aforementioned location to be appraised using the comparative cases retrieved by the aforementioned comparative case retrieving means.

According to the second principal aspect of the present invention, a loan intermediary processing method is offered, which is a loan intermediary processing method that acts as intermediary for a loan applicant and loan-providing financial institutions, comprising a loan application receiving step for receiving the loan application from the aforementioned loan applicant, a loan terms storing step for storing the terms of the loan from a plurality of financial institutions, a financial institution selecting step to comparing the aforementioned loan application and the terms of the loan from each financial institution and selecting the financial institutions, the loan terms of which meet the application, a loan application sending step for sending the loan application of the aforementioned loan applicant to only the financial institutions selected in the aforementioned financial institution selecting step, and an examination result summary presenting step for receiving the examination results of the aforementioned loan application from the aforementioned financial institutions, and presenting the summary result to the aforementioned loan applicant.

According to this configuration, the processing procedure that can be executed by the aforementioned loan intermediary processing system can be obtained.

Further, the other features of the present invention and remarkable effects will be clearly understood by the people with appropriate skills by referring to the following embodiments of the invention and the attached drawings.

### BRIEF DESCRIPTION OF THE DRAWINGS

FIG. 1 is a schematic block diagram illustrating an embodiment of the present invention.

FIG. 2 is a flow chart illustrating an embodiment of the present invention.

FIG. 3 is a block diagram illustrating the loan application sending intermediary system.

FIG. 4 is a block diagram illustrating the real estate appraisal auxiliary system.

FIG. 5 is a flow chart illustrating the real estate value assessment step.

FIG. 6 is a diagram illustrating an example of map display.

FIG. 7 is a diagram illustrating a screen display of a use zoning obtaining result.

FIG. 8 is a diagram illustrating an example of comparative case retrieving result screen display.

FIG. 9 is a diagram illustrating an example of standard land value computation result screen display.

FIG. 10 is a diagram illustrating a real estate value assessment program.

### DETAILED DESCRIPTION OF THE PREFERRED EMBODIMENT

Next, an embodiment of the present invention will be explained based on the drawings.

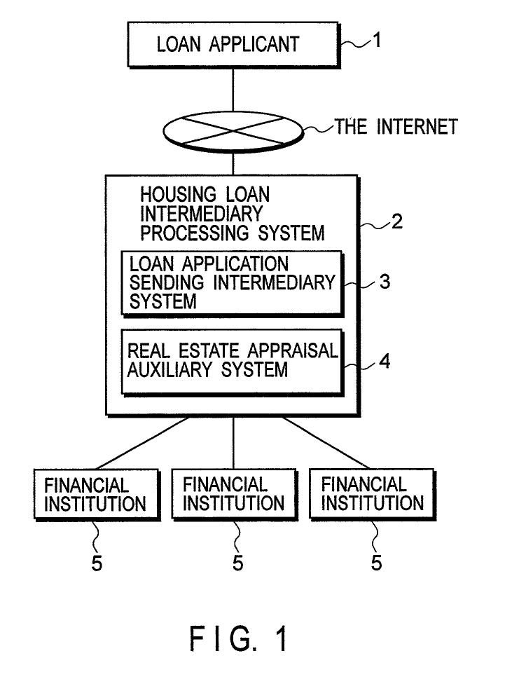

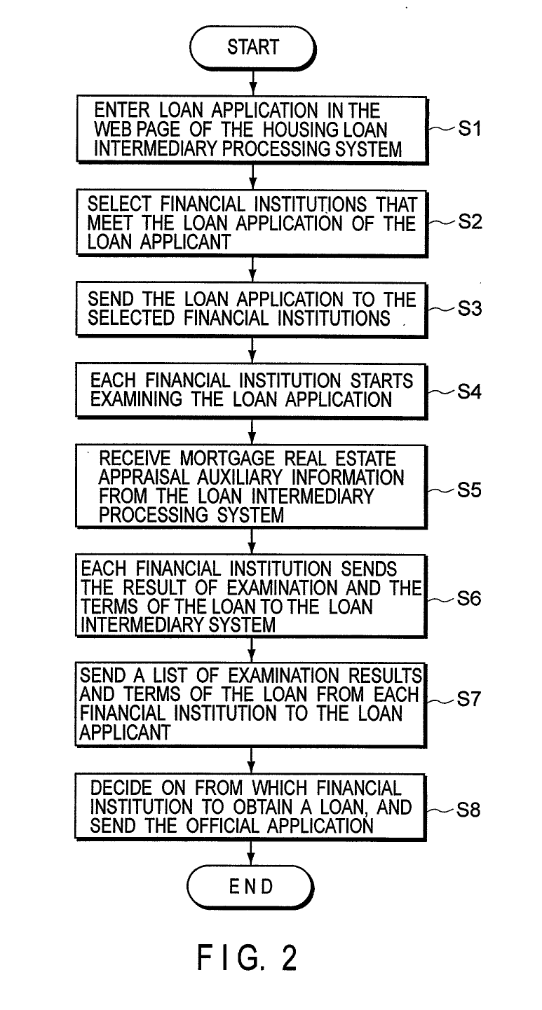

FIG. 1 is a schematic block diagram, which illustrates a housing loan intermediary processing system in accordance with the present embodiment. FIG. 2 is a flow chart, which illustrates an example of the processing flow in this system. The reference numerals S1-S8 indicated in each FIG. are keys to refer to the processing steps, which correspond to the step numbers (Steps S1-S8) in the following explanation.

Basic Configuration

First, as illustrated in FIG. 1, the housing loan intermediary processing system 2 in this embodiment is connected to a housing loan applicant 1 through, for instance, the Internet. This housing loan intermediary processing system 2 is configured so that it receives a housing loan application from the aforementioned loan applicant 1, and processes this application through communication with a plurality of financial institutions 5. Here, the aforementioned housing loan intermediary processing system 2 is basically divided into two systems; i.e., a loan application sending intermediary system 3, which sends the loan application from the loan applicant 1 to the aforementioned financial institutions 5, and a real estate appraisal auxiliary system 4, which assists in the appraisal (assessment of the value) of the real estate at issue by the financial institutions 5.

Next, before explaining this housing loan intermediary processing system 2 in detail, the scheme of the process that uses this system will be briefly explained in reference to FIG. 2.

First, the aforementioned loan applicant 1 accesses the loan application entry page of the aforementioned housing loan intermediary processing system 2 on line through, for instance, the Internet (Step S1). This page has columns to enter the income of the loan applicant, the location of the mortgage real estate, the address of the loan applicant, the password to confirm the identification, and other information that the financial institutions 5 need to examine the repayment ability of the loan applicant 1. The loan applicant 1 enters necessary information in these columns.

Then, the aforementioned housing loan intermediary processing system 2 selects the financial institutions 5 that meet the terms of the loan application made by the aforementioned loan applicant 1 (Step S2). It then sends the information on the loan applicant 1 entered at the time of application only to these selected financial institutions 5 in a data format appropriate for the application to each financial institution (Step S3). The aforementioned selection of financial institutions 5 is automatically executed by comparing the information entered by the aforementioned loan applicant with the terms that have been pre-received from each financial institution 5.

Then, the financial institutions 5 that have received the aforementioned loan application will examine this application (Step S4). At the time of this examination, the appraisal of the mortgage value of the mortgage real estate may be needed. When the appraisal of the real estate mortgage value is needed, the financial institution 5 can instantaneously obtain the auxiliary appraisal information based on the location of the mortgage real estate from the real estate appraisal auxiliary system 4 of the aforementioned housing loan intermediary processing system 2 (Step S5).

Then, each of the aforementioned financial institutions 5 examines the said housing loan taking into consideration the mortgage real estate value, and sends the determined examination result and the terms of the housing loan to the aforementioned housing loan intermediary processing system 2 (Step S6).

After receiving the aforementioned examination results and the terms of the loan from all financial institutions 5, the aforementioned housing loan intermediary processing system 2 summarizes the information received from each of the financial institutions 5, in a table format (Step S7). Then, it reports this summary result to the aforementioned loan applicant 1. At this time, the loan applicant 1 may be allowed to see the aforementioned table on line using the password, or the information may be reported by e-mail. The loan applicant can consider the terms of the loan from each financial institution 5 based on this table, decide on the financial institution 5 to use, and send an official application through this system (Step S8).

To materialize the processing above, the housing loan intermediary processing system 2 in this embodiment is configured as follows: Here, the configuration of this housing loan intermediary processing system 2 is explained being divided into the aforementioned two systems: The loan application sending intermediary system 3 and the real estate appraisal auxiliary system 4. Further, the keys S1-S8 in the following explanation correspond to the reference keys for each of the steps explained above.

Loan Application Sending Intermediary System

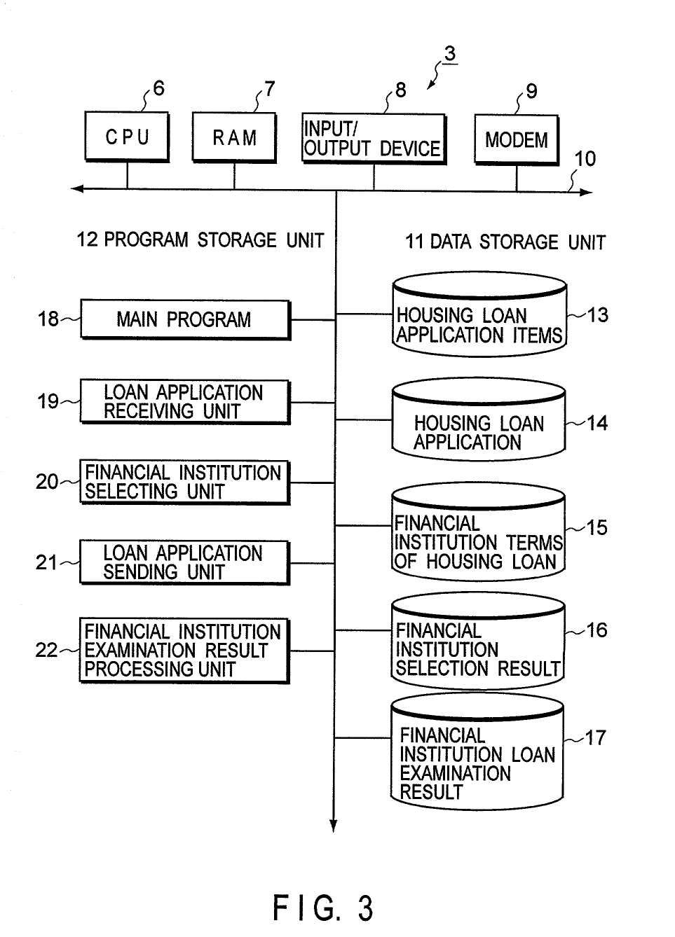

FIG. 3 is a block diagram, which illustrates this loan application sending intermediary system 3. As illustrated in this Fig., this system 3 is comprised by connecting a data storing unit 11 and a program storage unit 12 to a bus 10 comprised by connecting a CPU 6, a RAM 7, an input/output device 8, a modem 9, etc.

First, the data storage unit 11 comprises a housing loan application item storing unit 13, a housing loan application storing unit 14, a financial institution terms of housing loan storing unit 15, a financial institution selection result storing unit 16, and a financial institution loan examination result storing unit 17.

The housing loan application item storing unit 13 stores the entry items that prompt the loan applicant 1 to enter the information. These entry items are determined by receiving from each of the aforementioned financial institutions the application items required by the financial institution 5, and summing them up in terms of the highest common factors.

The aforementioned housing loan application storing unit 14 stores the data in the loan application received from the aforementioned loan applicant 1 being related with the aforementioned entry items stored in the aforementioned housing loan application item storing unit 13.

The financial institution housing loan terms storing unit 15 stores the terms of the loan for each financial institution 5 used to select the financial institutions 5 to which the application by the aforementioned loan applicant 1 is sent.

The financial institution selection result storing unit 16 stores the financial institutions 5 selected as one to send the loan application of the aforementioned loan applicant 1 being related to each loan applicant 1. This selection result will be used as the information for tracking the response from each of the selected financial institutions 5.

The financial institution loan examination result storing unit 17 stores the final examination result from each financial institution 5. In this embodiment, the approval or rejection of the loan, and the terms of the loan when approved are stored in a table.

On the other hand, the aforementioned program storage unit 12 comprises, besides the main program 18, a loan application receiving unit 19, a financial institution selecting unit 20, a loan application sending unit 21, and a financial institution examination result processing unit 22.

The loan application receiving unit 19 has the function of reading the aforementioned entry items stored in the aforementioned housing loan application item storing unit 13 and presenting them to the aforementioned loan applicant 1 (corresponds to Step S1). This presentation is made by displaying them through the Internet on the browser of the computer system that the aforementioned loan applicant 1 has. As mentioned earlier, the aforementioned loan applicant 1 can enter the necessary information for each entry item. Then, this loan application receiving unit 19 stores the information entered by the loan applicant 1 in the aforementioned housing loan application storing unit 14. As mentioned earlier, this information is stored for each loan applicant 1 being related with the aforementioned entry items stored in the aforementioned housing loan application item storing unit 13.

The aforementioned financial institution selecting unit 20 has the function of selecting, based on the information on the loan applicant 1 stored in the aforementioned housing loan application storing unit 14, the financial institutions 5 that meet this terms from among a plurality of financial institutions 5 (corresponds to Step S2). In other words, this financial institution selecting unit 20 takes out the terms of the loan set by each financial institution 5 from the aforementioned financial institution housing loan terms storing unit 15, and by comparing this with the information entered by the aforementioned loan applicant 1, it eliminates the financial institutions 5 that cannot meet the terms of the loan applicant 1, and selects the financial institutions 5 that meet the terms. At this time, if no financial institution 5 can meet the terms, it reports the fact to the loan applicant 1 and displays a message urging him to change the terms. After the selection of financial institutions 5 has been completed, it stores the information on the selected financial institutions 5 being related to the aforementioned loan applicant 1.

The aforementioned loan application sending unit 21 has the function of sending, based on the selection result in the aforementioned financial institution selecting unit 20, the loan application of the aforementioned loan applicant 1 to the member financial institutions 5 that meet the aforementioned terms of the loan (corresponds to Step S3). At this time, this loan application sending unit 21 sends the aforementioned loan application in a data format requested by each financial institution 5. Further, the aforementioned loan application data may be outputted in a loan application form, which is different for each financial institution 5, and the application form may be sent to each financial institution 5.

The financial institution examination result processing unit 22 has the function of receiving the examination result and the terms of the loan from each financial institution 5 and storing this in the financial institution loan examination result storing unit 17 (corresponds to Step S6). Then, this financial institution examination result processing unit 22 sums up the terms of the loan presented by each financial institution 5 in a table format, and reports them to the loan applicant 1 (corresponds to Step S7). With regard to the aforementioned reporting method to the loan applicant 1, the loan applicant may be allowed to see the table at, for instance, a website on the Internet using password, etc.; or this housing loan intermediary processing system 2 may report them by e-mail, etc. Based on this report, the loan applicant 1 can compare the terms of the loan from each financial institution 5, and decide on the financial institution 5 to use. Then, based on the fact that the aforementioned loan applicant 1 has selected one financial institution 5 from the aforementioned table, this financial institution examination result processing unit 22 will send an official loan application by the aforementioned loan applicant 1 to the said financial institution 5 (corresponds to Step S8).

Real Estate Appraisal Auxiliary System

Next, the aforementioned real estate appraisal auxiliary system 4 will be explained. This system 4 is for each financial institution 5 who has received the aforementioned loan application in Step S3 in FIG. 2 to use to assess the value of the real estate that will be the mortgage. As will be explained later, this system 4 has already received and stored the property terms (mortgage real estate information) such as the address, etc. of the mortgage real estate of the aforementioned loan applicant 1, so each financial institution 5 can assess the real estate value without reentering such information.

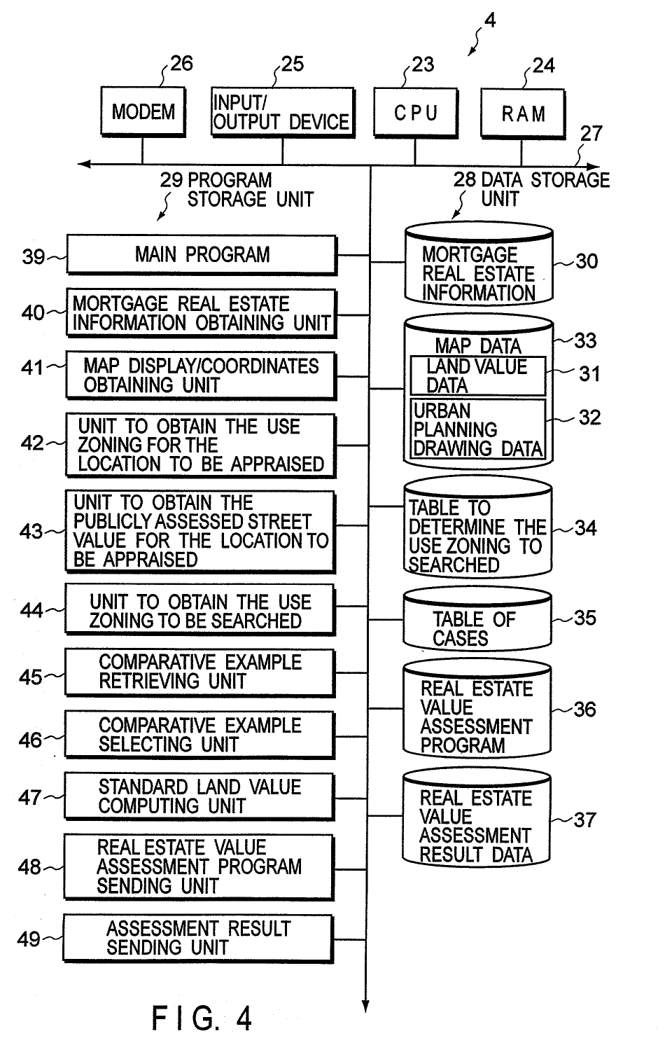

FIG. 4 is a block diagram, which illustrates the real estate appraisal auxiliary system 4. As illustrated in this Fig., this system 4 is comprised by connecting a data storing unit 28 and a program storage unit 29 to a bus 27, which is comprised by connecting a CPU 23, a RAM 24, an input/output device 25, a modem 25, etc.

The data storage unit 28 stores a mortgage real estate information storing unit 30, which receives and stores the property information of the mortgage real estate of the aforementioned loan applicant 1 from the aforementioned loan application sending intermediary system 3, a map data storing unit 33 comprised by relating the land value data 31 and the urban planning drawing data 32, a table to determine the use zoning for search 34, a table of cases 35, which stores detailed evaluation data for each case, a real estate value assessment program 36, and a real estate value assessment result data 37.

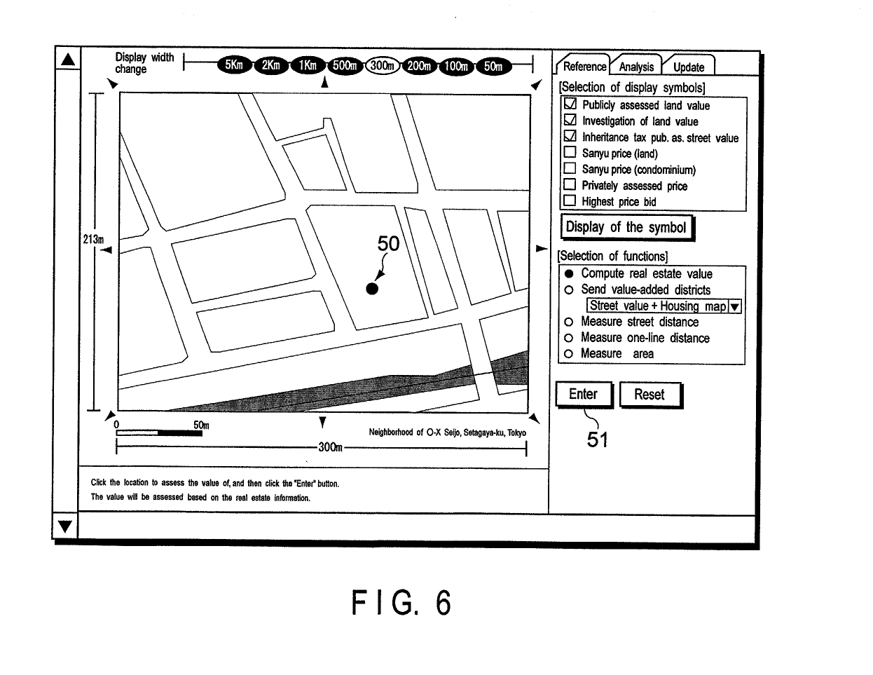

The map data stored in the aforementioned map data storing unit 33 specifically comprises a residential map in each scale (See FIG. 6), and the map coordinate conversion table (not illustrated), which relates the aforementioned land value data 31 and urban planning drawing data 32 with the coordinates on this map. Further, the aforementioned residential map specifically comprises a plurality of files stored being divided in dimensions (See FIG. 6) that correspond to the predetermined scales.

Meanwhile, the land value data 31 comprises the name of each location and the land value of the location contained in the publicly assessed land value data, the investigation of land value data, the privately assessed evaluation data and the data on the highest price bid. The name of the location in this land value data 31 has been registered in the aforementioned map coordinate conversion table, and is related to the coordinates on the aforementioned map. Therefore, when this land value data is renewed, it is necessary to also correct the aforementioned coordinate conversion table and renew it.

Further, the aforementioned urban planning drawing data 32 comprises the use zoning data (Type one exclusively residential zone, commercial zone and other zoning types) on the aforementioned map, and the property data such as building-to-land ratio and floor area ratio. When these are renewed, it is also necessary to add new data to the aforementioned coordinate conversion table.

Besides, the case table 35 stores detailed evaluation on the locations (locations of the cases, publicly assessed locations and evaluated locations) embedded in the aforementioned map data along with their use zonings.

Further, the table to determine the use zonings for search 34 is a table to determine the use zonings for the cases to be searched when the aforementioned case table 35 is searched based on the use zoning of the predetermined location to be appraised (not illustrated).

The real estate value assessment program 36 stores information on individuality so as to further add individuality to the standard land value pre-computed by this system and the property information on the location to be searched to improve the reliability of the assessed value. This assessment program 36 may be JAVA or spreadsheet software, etc. that can be run on the system of the financial institution.

Meanwhile, the aforementioned program storage unit 29 stores, besides the main program 39, a mortgage real estate information obtaining unit 40, a map display/coordinates obtaining unit 41, a unit to obtain the use zoning for the location to be appraised 42, a unit to obtain the publicly assessed street value for the location to be appraised 43, a unit to obtain the use zoning for search 44, a comparative case retrieving unit 45, a comparative example selecting unit 46, a standard land value computing unit 47, a real estate value assessment program sending unit 48, and an assessment result sending unit 49.

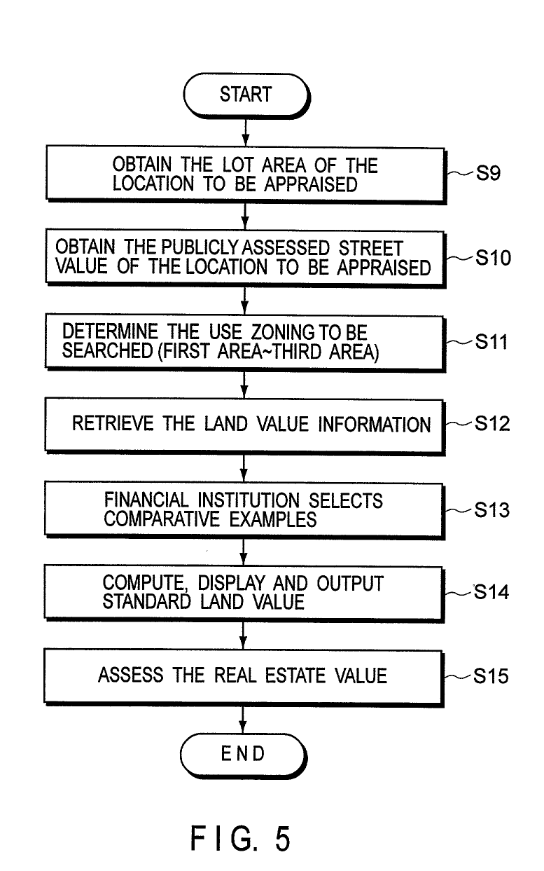

These components are actually comprised of a plurality of programs or subroutines, which are called onto the RAM 24 by the aforementioned CPU 23 and executed. Next, detailed functions and operations of these components will be explained in reference to the flow chart illustrated in FIG. 5 and the screen display examples illustrated in FIGS. 6-9.

First, the aforementioned mortgage real estate information obtaining unit 40 has the function of receiving the mortgage real estate information (street number, etc.) in the application information entered by the aforementioned loan applicant 1 from the aforementioned loan application sending intermediary system 3, and storing this in the aforementioned mortgage real estate information storing unit 30.

The aforementioned map display/coordinates obtaining unit 41 has the function of arranging the map data containing the real estate specified by the loan applicant 1 based on the information stored in the aforementioned mortgage real estate information storing unit 30 in a format that can be displayed on the terminal of the financial institution 5 and sending it. In this embodiment, the range of the map is automatically specified based on the address of the aforementioned mortgage real estate, and the predetermined map data in the scale corresponding to the specified range is taken out of the aforementioned map data storing unit 33. Then, it will be displayed as illustrated in FIG. 6.

In this embodiment, the location of the aforementioned mortgage real estate will be indicated with, for instance, a dot (indicated with the key 50 in the Fig.) on the aforementioned map. For instance, by clicking the location using a mouse, the coordinates of the location will be obtained. This display of the data and obtaining of the coordinates will be, in actuality, materialized as the aforementioned map display/coordinates obtaining unit 41 sends and runs a map display program such as JAVA applet on the terminal of the financial institution 5.

To start the real estate value computing step using this program for this location to be appraised, click the Enter button 51. When this Enter button 51 is clicked, the real estate value computing step (Steps S9-S15) illustrated in FIG. 5 will be executed. Next, this computing step will be explained.

When this step is started, first, the aforementioned unit to obtain the use zoning for the location to be appraised 42 obtains the use zoning of the said location to be appraised based on the coordinates of the location to be appraised on the map obtained by the aforementioned map display/coordinates obtaining unit 41 (Step S9). Specifically, by accessing the urban planning drawing data 32 related to the aforementioned map data, the use zoning of the said location and its property is obtained.

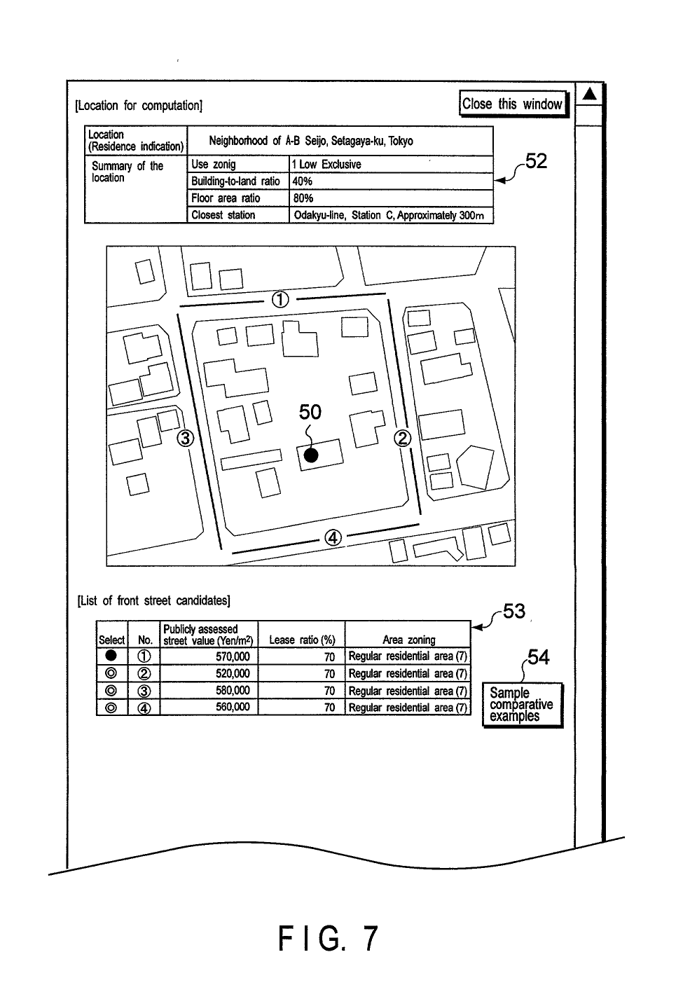

FIG. 7 illustrates a screen that displays the result of the execution. In this example, as indicated with the key 52 in the Fig., the aforementioned location to be appraised is “neighborhood of A-B Seijo, Setagaya-ku, Tokyo-to,” and the use zoning is “Type 1 low building exclusively residential zone.” The property includes, “the building-to-land ratio of 40%, the floor area ratio of 80%, and the closest station of Station C, which is approximately 300 m away.”

Next, the aforementioned unit to obtain the publicly-assessed street value for the location to be appraised 43 obtains the publicly-assessed street value of the streets that are in contact with the said location to be appraised from the aforementioned map data (land value data 31) based on the coordinates obtained by the aforementioned map display/coordinates obtaining unit 41 (Step S10). In the example illustrated in FIG. 7, the publicly-assessed street values of the four streets 1-4 that encircle the aforementioned location to be appraised 50 are obtained and displayed in the column indicated with the key 53 in the Fig.

Meanwhile, the unit to obtain the use zoning for search 44 determines a plurality of use zonings for search by applying the use zoning of the aforementioned location to be appraised obtained by the aforementioned unit to obtain the use zoning for the location to be appraised 42 to the aforementioned table to determine the use zonings for search 34 (Step S11).

Then, when the financial institution 5 clicks the comparative case retrieving button 54, the aforementioned comparative case retrieving unit 45 retrieves comparative cases from the aforementioned case tables 35 based on the publicly-assessed street value obtained by the aforementioned unit to obtain the publicly-assessed street value for the location to be appraised 43 and the use zonings for search determined by the aforementioned unit to obtain the use zoning for the location to be appraised 42, etc. (Step S12).

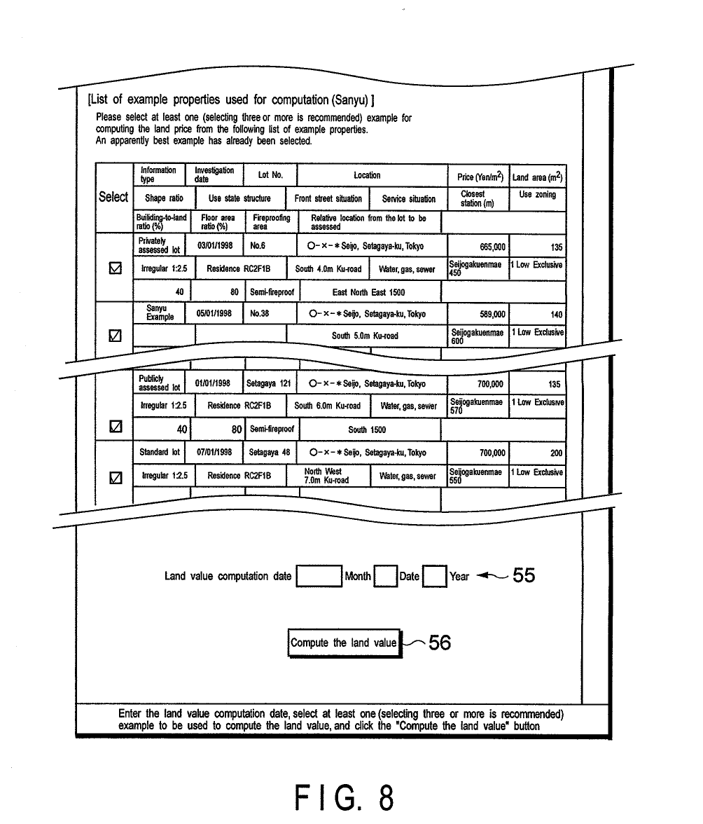

The cases searched in this comparative case retrieving step are displayed in the screen illustrated in FIG. 8. In this step, several appropriate use zonings can be determined as comparative cases to assess the value of the location to be searched, and be searched. Thus, a certain number of cases or more can be secured even if there are few cases in the same use zoning in the vicinity. Also, as the cases in the same use zoning as the use zoning of the location to be appraised will be displayed first, it will be more convenient for the financial institution 5, providing the effect of preventing displaying of more than necessary cases.

Then, after the financial institution 5 has freely selected the comparative cases from among the displayed cases to be used to compute the standard land value (Step S13), and entered the date to compute the value in the column indicated with the key 55 in FIG. 8, by clicking the land value computing button 56, the aforementioned standard land value computing unit 47 computes the standard land value of the location to be appraised (Step S14). The standard land value is specifically computed as follows: “Standard Land Value=Value of Case×Time Correction Factor×Publicly-Assessed Street Value Ratio.”

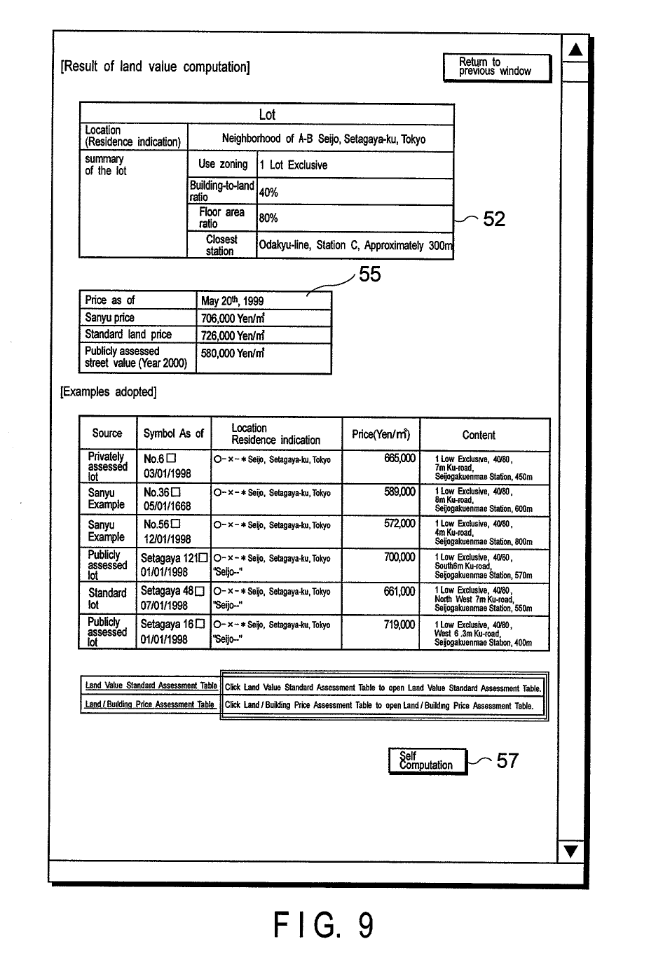

This computation result is illustrated in FIG. 9. According to this procedure, as only the cases that the financial institution 5 feels appropriate as a case to compute the land value are used for the computation, inappropriate cases can be excluded, and the reliability of land value computation will improve.

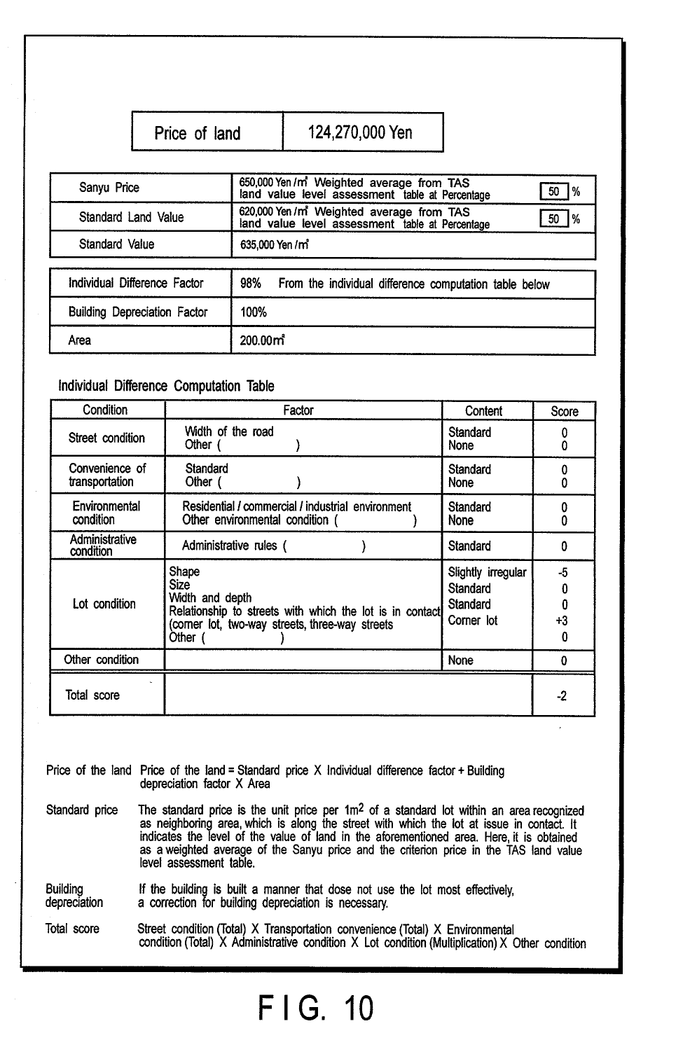

Then, by adding individuality to the aforementioned standard land value, the real estate value can be computed(assessed) (Step S15). Specifically, by clicking the real estate value assessment button indicated with the key 57 in FIG. 9, the aforementioned real estate value assessment program sending unit 48 sends the real estate value assessment program 36 such as illustrated in FIG. 10 to the terminal of the financial institution 5 (corresponds to Step 5 in FIG. 2). In this program 36, the standard land value and the other information obtained earlier have been transferred, and the program has the function of automatically computing the value of the real estate at issue when each financial institution 5 enters information in the other columns based on the individuality.

The real estate assessment value computed in this manner is stored as the aforementioned real estate value assessment result data 37, as well as being sent to each financial institution 5 by the aforementioned assessment result sending unit 49. Then, this real estate assessment value will be used to determine the final approval or the rejection of the loan by each financial institution 5, and the examination result determined in this manner will be sent to the aforementioned housing loan intermediary processing system 2 (corresponds to Step S6 in FIG. 2).

According to the configuration explained above, the following effects can be realized.

First, according to the aforementioned configuration, there is an effect that the loan applicant can receive loan examination at a plurality of financial institutions 5 through one time of procedure.

In other words, in the aforementioned embodiment, the loan applicant needs to enter the desired terms of his loan application only once into the aforementioned housing loan intermediary processing system 2. Then, this system 2 sends the application to each of the financial institutions 5. In this manner, there is an effect that the applicant can send loan application to a plurality of financial institutions 5 and receive examination by them without visiting the respective offices of the financial institutions 5. Furthermore, as he can compare the examination results from a plurality of financial institutions 5, he can obtain the best loan for himself.

Second, according to the aforementioned embodiment, the financial institutions 5 that meet the loan application terms of the aforementioned loan applicant 1 are selected from among a plurality of financial institutions 5, and the aforementioned loan application is sent only to these financial institutions 5. In this manner, unnecessary examination procedure at financial institutions 5 can be eliminated. Furthermore, there is an effect that the processing load of examination results from the financial institutions 5 in this system 2 can be reduced.

Third, when each of the financial institutions 5 needs assessment of the mortgage real estate, the auxiliary information such as standard land value necessary for the appraisal of the mortgage real estate can be offered to each financial institution 5 based on the loan application entered by the loan applicant. In this manner, redundant labor at each financial institution 5 can be reduced, and faster examination process can be expected.

The embodiment explained above is only one embodiment of the present invention. Variations can be made within the scope of the invention without changing the substance of the invention.

According to the configuration explained above, a loan intermediary processing system and method thereof can be offered, which can reduce the labor of both the loan applicant and the financial institutions in the loan application and its examination process.

What is claimed is:

1 A loan intermediary processing system that acts as intermediary for a loan applicant and loan-providing financial institutions, said the loan intermediary processing system comprising:
a loan application receiving means for receiving a loan application from said loan applicant,
a loan terms storing means for storing the terms of loans from a plurality of financial institutions,
a financial institution selecting means for comparing said loan application and the terms of the loan from each financial institution and selecting the financial institutions, the loan terms of which meet the application,
a loan application sending means for sending the loan application of said loan applicant only to the financial institutions selected by said financial institution selecting means, and
an examination result summary presenting means for receiving the examination result of said loan application from each of said financial institutions, summing it the examination result, and presenting the summary result to said loan applicant.

2 The system according to claim 1, wherein said system further comprises a mortgage real estate value assessing auxiliary means for generating auxiliary information to assess the real estate value of the mortgage real estate of the loan applicant.

3 The system according to claim 1, wherein said loan application sending means obtains only the information required by each financial institution from said loan application and sends it to each financial institution.

4 The system according to claim 2, wherein said mortgage real estate assessing auxiliary means comprising:
a map data storing means comprised by relating land value information and urban planning drawing information on a plurality of locations with their position coordinates on a map,
a use zoning obtaining means for obtaining the use zoning of the said location to be appraised from said urban planning drawing information if a location to be appraised has been specified on a map,
a comparative case retrieving means for retrieving comparative cases for the said location to be appraised based on the use zoning obtained by this use zoning obtaining means, and
a standard land value computing means for computing the standard land value of said location to be appraised based on the comparative cases retrieved by said comparative case retrieving means.

5 The system according to claim 4, wherein said mortgage real estate value assessing auxiliary means further comprises a publicly-assessed street value obtaining means for obtaining, based on said location to be appraised, the publicly-assessed street value of the streets with which the location at issue is in contact, and wherein
said comparative case retrieving means retrieves, in reference to said publicly-assessed street value, only the comparative cases whose difference from the said publicly-assessed street value is within a predetermined range.

6 The system according to claim 4, wherein said comparative case retrieving means retrieves only the comparative cases within a predetermined range in reference to said location to be appraised.

7 The system according to claim 4, wherein said comparative case retrieving means searches comparative cases for a plurality of use zonings to be searched including the use zoning obtained by said use zoning obtaining means, and retrieves the said comparative cases that have been searched being associated with respective use zonings.

8 The system according to claim 4, wherein said standard land value computing means computes the standard land value of said location to be appraised using the comparative cases retrieved by said comparative case retrieving means.

9 A loan intermediary processing method to act as intermediary for a loan applicant and loan-providing financial institutions, said loan intermediary processing method comprising:
a loan application receiving step for receiving a loan application from said loan applicant,
a loan terms storing step for storing the terms of loans from a plurality of financial institutions,
a financial institution selecting step for comparing said loan application and the terms of the loan from each financial institution, and selecting the financial institutions, the loan terms of which meet the application,
a loan application sending step for sending the loan application of said loan applicant only to the financial institutions selected in said financial institution selecting process, and
an examination result summary presenting step for receiving the examination results of said loan application from said financial institutions, and summing them up, and presenting the summary result to said loan applicant.

10 The method according to claim 9, wherein said method further comprises a mortgage real estate value assessing auxiliary step for generating auxiliary information to assess the real estate value of the mortgage real estate of the loan applicant, and sending said information to each financial institution.

11 The method according to claim 9, wherein said loan application sending step obtains only the information required by each financial institution from said loan application and sends said information to each financial institution.

12 The method according to claim 10, wherein said mortgage real estate value assessing auxiliary step comprising:
a map data storing step for associating the land value information and the urban planning drawing information on a plurality of locations with their position coordinates on a map,
a use zoning obtaining step for obtaining the use zoning of the said location to be appraised from said urban planning drawing information if a location to be appraised has been specified on a map,
a comparative case retrieving step for retrieving comparative cases for the said location to be appraised based on the use zoning obtained in this use zoning obtaining step, and
a standard land value computing step for computing the standard land value of said location to be appraised based on the comparative cases retrieved in said comparative case retrieving step.

13 The method according to claim 12, wherein said mortgage real estate value assessing auxiliary step further comprises a publicly-assessed street value obtaining step for obtaining the publicly-assessed street value of the streets with which the location at issue is in contact based on said location to be appraised,
and wherein said comparative case retrieving step, in reference to said publicly-assessed street value, retrieves only the comparative cases whose difference from the said publicly-assessed street value is within a predetermined range.

14 The method according to claim 12, wherein said comparative case retrieving step retrieves only the comparative cases within a predetermined range in reference to said location to be appraised.

15 The method according to claim 12, wherein said comparative case retrieving step searches comparative cases for a plurality of use zonings to searched including the use zoning obtained in said use zoning obtaining step, and retrieves said searched comparative cases being associated with respective use zonings.

16 The method according to claim 12, wherein said standard land value computing step, using the comparative cases retrieved in said comparative case retrieving step, computes the standard land value of said location to be appraised.
